(19) United States
(12) Patent Application Publication
(10) Pub. No.: US 2023/0130752 A1
(43) Pub. Date: Apr. 27, 2023

(54) SYSTEM AND METHOD FOR OPTIMIZING PLATFORM CONVERSION THROUGH DYNAMIC MANAGEMENT OF CAPACITY IN AN ECOMMERCE ENVIRONMENT

(71) Applicant: FLIPKART INTERNET PVT LTD., Bengaluru (IN)

(72) Inventors: Harish POLAMPALLI, Manuguru (IN); Rahul RAGHUWANSHI, Bhopal (IN); Gowtham BELLALA, Visakhapatnam (IN); Monica N S, Bengaluru (IN); Angad Anand SAXENA, Kota (IN)

(73) Assignee: FLIPKART INTERNET PVT LTD., Bengaluru (IN)

(21) Appl. No.: 17/914,669

(22) PCT Filed: Mar. 25, 2021
(86) PCT No.: PCT/IN2021/050312

§ 371 Date: Sep. 26, 2022

(30) Foreign Application Priority Data
Mar. 28, 2020 (IN) 202041013707

(51) Int. Cl. G06Q 30/0202; G06Q 30/0601

(52) U.S. Cl. CPC G06Q 30/0202; G06Q 30/0633

(57) ABSTRACT

The invention relates to optimizing platform conversion through dynamic management of capacity in an ecommerce environment. The invention commences when a request is received from a user to place an order for an item in the ecommerce environment. The request is then transmitted to a server. A first buying cohort with an associated first prioritization value is then identified. A utilization value of a first capacity reservation for the identified first buying cohort is then determined. Thereafter, if the determined utilization value of the first capacity reservation is more than a predefined threshold value, a extraction capacity value from at least one second capacity reservation is dynamically assigned to the first capacity reservation based on a dynamically forecasted demand and a risk factor associated with at least one second capacity reservation.

### TECHNICAL FIELD

The present disclosure relates generally to the ecommerce environment, and more particularly, to a system and method for optimizing platform conversion through dynamic management of capacity in an ecommerce environment.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

With the exponentially increasing facilities provided over the internet, customers nowadays have the comfort of ordering goods and services over the internet while sitting remotely in the comfort of their homes, or any other surroundings. This ease and accessibility to a plethora of services offered by various platforms over the internet, known as ecommerce platforms, has led to a substantial increase in the number of customers of these ecommerce platforms. Ever increasing demand with high variability meant a capacity constrained environment with delays in shipping more often than not. Whenever such scenarios occur (spillages), the users buying products online see relatively poor speed of deliveries and hence, the no. of users converting to customers by buying products reduces.

Analyzing closely, it is observed that different customers have different expectations when it comes to delivery speed. Accordingly, the drop-in conversion when poor Service Level Agreements (SLAs) also varies across buying cohorts. As a result, in scenarios of increased demand, there is a need to better manage the available capacity, thus selectively improving the speed for highly SLA sensitive buying cohorts over the relatively lower ones to improve conversions.

In the industry, currently, the capacity allocation to any demand is done in a First Come First Serve (FCFS) manner. The customer arriving first on the platform gets the capacity allocated for his order on a priority basis. Whenever a situation of excessive demand occurs, customers arriving on the platform when the capacities for the day are full receive poor experience with respect to speed. In case of speed sensitive customers, this situation often leads to business losses. For example, an order from a priority customer for purchase of a mobile phone may be delayed if fulfillment capacity for the day is full. In such a case, the customer's order gets shipped whenever the capacity is available next. This results in an experience lower than the customer's expectation, a scenario which may result in such customers not placing the order and/or bad brand perception with respect to speed in the mind of the customer.

It has been observed that when the capacities are offered on a FCFS basis by an ecommerce platform to address various orders of customers, sometimes, customers who aren't a priority w.r.t. delivery speed (low sensitivity to SLA) end up receiving better speeds for their orders compared with those of high priority (high sensitivity to SLA) customers. This often leads to dissatisfaction on part of high priority customer and conversion loss, as the high priority customers may develop a negative perception of the platform and then, subsequently, may not order again from the ecommerce platform in the future.

Therefore, it is apparent from the aforementioned problems, that there exists a need to provide for a system that provides for an automated mechanism for managing capacity, making capacities available to buying cohorts based on their delivery speed sensitivity so that SLAs are available to buying cohorts as per their expectations and the overall conversion is improved.

### SUMMARY OF THE INVENTION

This section is provided to introduce certain objects and aspects of the present invention in a simplified form that are further described below in the detailed description. This summary is not intended to identify the key features or the scope of the claimed subject matter. In order to overcome at least a few problems associated with the known solutions as provided in the previous section, an object of the present invention is to provide for optimizing platform conversion through creation of capacity reservation for identified delivery speed sensitive buying cohorts and dynamic management of capacity in an ecommerce environment.

It is another object of the present invention to provide for an automated mechanism for managing capacity reservations while taking into account the various risks associated with each capacity.

It is yet another object of the present invention to account for the varying delivery speed sensitivity associated with each customer segment.

It is yet another object of the present invention to increase the conversion rate of the customer segments.

It is yet another object of the present invention to manage the capacity reservations of various customer segments by dynamically allocating resources from the capacity reservations based on delivery speed sensitivity, a forecasted demand and associated risk factors.

It is another object of the present invention to provide for dynamic capacity management to optimize platform conversions in an ecommerce environment.

It is yet another object of the present invention to provide for risk managed predictive capacity allocations by associating a risk factor with each possible capacity assignment.

It is yet another object of the present invention to provide for reallocation of capacity reservations based on minimum risk associated with capacity reservation assignment.

It is yet another object of the present invention to provide for a higher conversion rate for customers.

It is yet another object of the present invention to provide for scalability in providing capacity reservations by managing a large number of capacity reservations.

It is yet another object of the present invention to manage capacity reservation assignments for many customer segments simultaneously.

In view of the aforesaid objects of the present invention, a first aspect of the present invention relates to a method for optimizing platform conversion through dynamic management of capacity in an ecommerce environment. The method commences when a request is received from a user, via a user equipment, to place an order for an item in the ecommerce environment. The request is then transmitted to a server. A first buying cohort is then identified for the user with an associated first prioritization value. A first utilization value of a first capacity reservation for the identified first buying cohort is then determined. Thereafter, if the determined first utilization value of the first capacity reservation is more than a predefined threshold value, a second extraction capacity value from at least one second capacity reservation is dynamically assigned to the first capacity reservation based on a dynamically forecasted demand associated with at least one second buying cohort and a risk factor.

Another aspect of the disclosure relates to a system for optimizing platform conversion through dynamic management of capacity in an ecommerce environment. The system comprises a user device receiving a request to place an order for an item from a user in the ecommerce environment. The request is then transmitted to a server. The server receives the request and identifies a first buying cohort for the user with an associated first prioritization value. A first utilization value of a first capacity reservation for the identified first buying cohort is then determined by the server. Thereafter, if the determined first utilization value of the first capacity reservation is more than a predefined threshold value, a second extraction capacity value from at least one second capacity reservation is dynamically assigned to the first capacity reservation based on a dynamically forecasted demand associated with at least one second buying cohort and a risk factor by the server.

### BRIEF DESCRIPTION OF THE DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components or circuitry commonly used to implement such components.

FIG. 1 illustrates an overview of an architecture of a system [100] for optimizing platform conversion through dynamic management of capacity in an ecommerce environment, in accordance with exemplary embodiments of the present invention.

FIG. 2 illustrates an architecture of a server [104] for optimizing platform conversion through dynamic management of capacity in an ecommerce environment, in accordance with exemplary embodiments of the present invention.

FIG. 3 illustrates a flow diagram depicting an exemplary method [300] for optimizing platform conversion through dynamic management of capacity in an ecommerce environment, in accordance with exemplary embodiments of the present invention.

The foregoing shall be more apparent from the following more detailed description of the invention.

### DETAILED DESCRIPTION OF THE INVENTION

In the following description, for the purposes of explanation, various specific details are set forth in order to provide a thorough understanding of embodiments of the present invention. It will be apparent, however, that embodiments of the present invention may be practiced without these specific details. Several features described hereafter can each be used independently of one another or with any combination of other features. An individual feature may not address any of the problems discussed above or might address only one of the problems discussed above. Some of the problems discussed above might not be fully addressed by any of the features described herein. Example embodiments of the present invention are described below, as illustrated in various drawings in which references such as numerals refer to the same parts throughout the different drawings.

The present invention provides a method and system for optimizing platform conversion through dynamic management of capacity in an ecommerce environment. As used herein in this disclosure, an ecommerce environment refers to a shopping platform which enables users to purchase goods and services, remotely, using the internet. The invention commences when a request is received from a user, via a user equipment, to place an order for an item in the ecommerce environment. The request is then transmitted to a server. A first buying cohort is then identified for the user with an associated first prioritization value by the server. A utilization value of a first capacity reservation for the identified first buying cohort is then determined by the server. Thereafter, if the determined utilization value of the first capacity reservation is more than a predefined threshold value, an extraction capacity value from at least one second capacity reservation is dynamically assigned to the first capacity reservation based on a dynamically forecasted demand associated with at least one second capacity reservation and a risk factor. In an embodiment, an alert may be generated when the determined utilization value of the first capacity reservation is more than the predefined threshold value. Finally, a total reserved capacity value of the first capacity reservation may further be dynamically changed based on the assigned extraction capacity value of the second capacity reservation.

As used herein, “connect”, “configure”, “couple” and its cognate terms, such as “connects”, “connected”, “configured” and “coupled” may include a physical connection (such as a wired/wireless connection), a logical connection (such as through logical gates of semiconducting device), other suitable connections, or a combination of such connections, as may be obvious to a skilled person.

As used herein, “send”, “transfer”, “transmit”, and their cognate terms like “sending”, “sent”, “transferring”, “transmitting”, “transferred”, “transmitted”, etc. include sending or transporting data or information from one unit or component to another unit or component, wherein the content may or may not be modified before or after sending, transferring, transmitting.

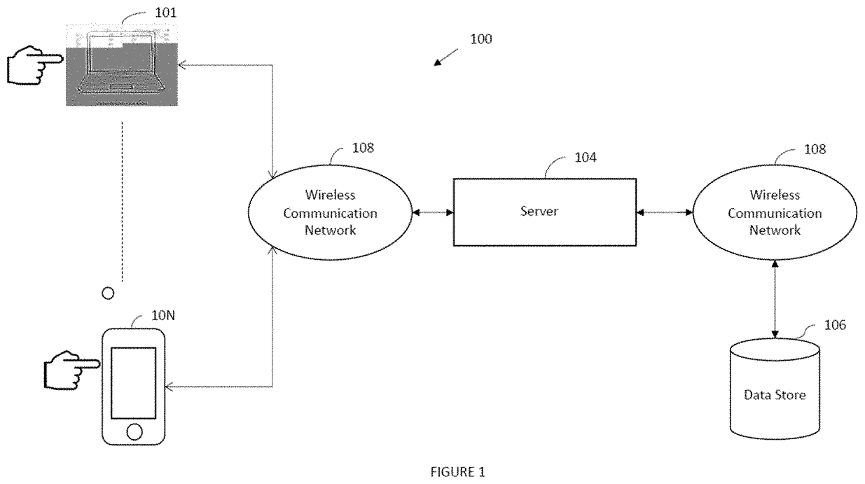

Referring to FIG. 1, an exemplary architecture of a system for optimizing platform conversion through dynamic management of capacity in an ecommerce environment is disclosed in accordance with exemplary embodiments of the present invention. The system [100] includes at least one user equipment [102A . . . 102N], server [104], a database [106] and a wireless communication network [108]. As used herein in this disclosure, the user devices [102A . . . 102N] may be collectively referred to as user device [102] without limiting the scope of the present disclosure. It will be understood by those of ordinary skill in the art that the structure shown is merely illustrative and does not limit the structure of the user equipment [102]. The user equipment [102] may also include more or less components than those illustrated in FIG. 1 or have a different configuration than that illustrated in FIG. 1.

As used herein, the user equipment [102] refers to any electrical, electronic, electromechanical and computing device. The user equipment [102] may include, but not limited to, a mobile phone, a tablet, a smartphone, a laptop, a wearable device, a personal digital assistant and any such device obvious to a person skilled in the art.

The wireless communication network [108] may be any wireless communication network capable to transfer data between entities of that network such as such as a carrier network including circuit switched network, a public switched network, a CDN network, a LTE network, GSM network and UMTS network, the Internet, intranets, local area networks, mobile communication networks, and combinations thereof.

The user equipment [102] is configured to receive a request from the user. The input received from the user may be to place a request for an item in an ecommerce environment. In an embodiment, the request received from the user may be to place an order to buy an item using the user device [102] from an ecommerce environment. The invention encompasses that the user equipment [102] may comprise a touch panel, a soft keypad, a hard keypad (including buttons) and the like. For example, the user may click a soft button on a touch panel of the user equipment [102] to confirm a shopping request to purchase a mobile device. In another example, the user may click on a soft button to purchase an iPhone mobile and a dress from an ecommerce platform.

In a preferred embodiment, the user equipment [102] may be configured to receive a request from the user via a graphical user interface on the touch panel. As used herein, a “graphical user interface” may be a user interface that allows a user of the user equipment [102] to interact with the user equipment [102] through graphical icons and visual indicators, such as secondary notation, and any combination thereof, and may comprise of a touch panel configured to receive an input using a touch screen interface. For example, the user equipment [102] may include a touch panel configured to collect the user's input via touch operation, thereon or near, and using a finger or a stylus. The invention encompasses that the detection of the touch on a graphical user interface of the user equipment [102] can be realized by various types such as resistive, capacitive, infrared, and surface acoustic waves.

The user equipment [102] is further configured to transmit the request received from the user to the server [104]. For example, the user equipment [102] may transmit the request received from the user to purchase a mobile device to the server [104].

The server [104] is configured to receive the request from the user equipment [102] via the wireless communication network [108]. The server [104] is configured to process the request received from the user in accordance with the working of the present invention as disclosed herein below. The server [104] is also configured to transmit information about each of the requests received from the user device [102] to the database [106]. As used herein, information related to one or more requests may include, but not be limited to, the buying cohort, the geographical location, at least one or more items.

As used herein, a server [104] includes one or more processors, wherein processor refers to any logic circuitry for processing instructions. A server [104] may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The server [104] may perform signal coding data processing, input/output processing, and/or any other functionality that enables the working of the system according to the present disclosure. More specifically, the server [104] is a hardware processor.

The database [106] is configured to store information related to one or more requests received from one or more users. The database [106] is also configured to store information related to one or more items in the ecommerce environment including, but not limited to, the amount of the one or more items, the quantity of the one or more items, the manufacturer of the one or more items. The database [106] may include, but is not limited to, a volatile memory, non-volatile memory, a remote storage, a cloud storage, high-speed random-access memory and/or non-volatile memory, such as one or more magnetic disk storage devices, one or more optical storage devices, and/or flash memory (e.g., NAND, NOR) or a combination thereof. The database [106] may be remotely configured relative to server [104] which may be connected to the user device [102] and the server [104] via the wireless communication network [108].

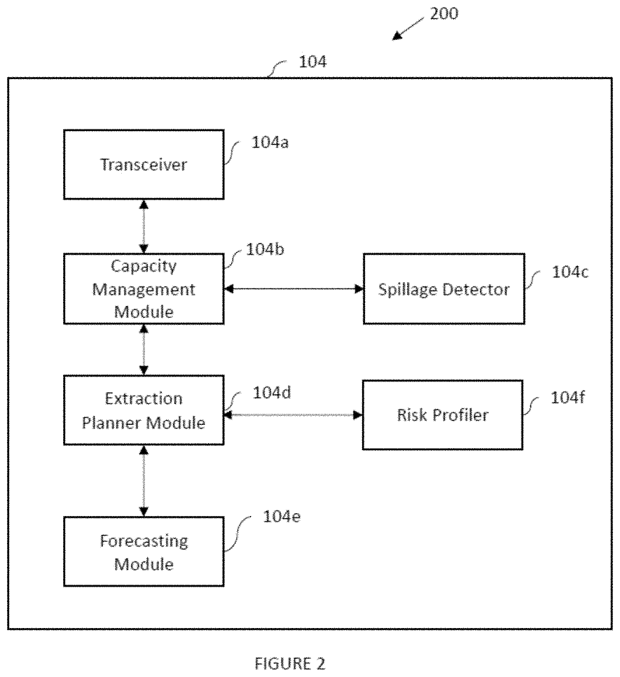

Now, FIG. 2 illustrates an architecture of a server [104] for optimizing platform conversion through dynamic management of capacity in an ecommerce environment, in accordance with exemplary embodiments of the present invention. As depicted in FIG. 2, the server [104] comprises a transceiver [104a], a capacity management module [104b], spillage detector [104c], extraction planner module [104d], forecasting module [104e] and risk profiler [104f]. The transceiver [104a] is configured to receive a request to place an order for at least one item on the ecommerce platform/environment. The request is received from at least one user device [102]. For example, a request may be received to buy a mobile phone from a user device [102]. In another example, an order may be received from a user device [102] to buy clothes from the ecommerce platform. The transceiver [104a] is further configured to transmit the request received to place an order for at least one item on the ecommerce platform to the capacity management module [104b].

The capacity management module [104b] is configured to receive a request to place an order for at least one item on the ecommerce platform from the transceiver [104a]. The capacity management module [104b] is further configured to identify a first buying cohort for the user of the user equipment [102]. As used herein in this disclosure, the first buying cohort is a customer segment comprising at least one customer sharing at least one common parameter such as a geographic location, delivery speed sensitivity, purchase of a certain item. For example, customers living in a metro city may be the first buying cohort. In another example, customers purchasing medicines may be the first buying cohort. The invention encompasses that there may be at least one second buying cohort for at least one customer segment comprising at least one customer sharing at least one common parameter such as a geographic location and delivery speed sensitivity, purchase of a certain item. For example, customers living in a village may be a second buying cohort. In another example, customers with low sensitivity to delivery speed may be the second buying cohort.

The invention encompasses that the first buying cohort has an associated first prioritization value. In an embodiment, at least one second buying cohort has an associated second prioritization value. As used herein, the prioritization value of the first buying cohort and the second buying cohort is a priority value of the buying cohort in the ecommerce environment and is based on at least one of a weighted preference value, delivery speed sensitivity and protection status. As used herein, the weighted preference value may comprise of a numeric, alphanumeric, percentage, symbol or any other value associated with the service level agreement of the buying cohort. As used herein, the total reserved capacity value of the associated capacity reservation may comprise of a numeric, alphanumeric, percentage, symbol or any other value indicating the total available reserved capacity assigned to a capacity reservation associated with the buying cohort. For example, the prioritization value of the first buying cohort may be the first priority value in the ecommerce environment as the weighted preference value of the buying cohort is high. In another example, the prioritization value of a second buying cohort may be the second priority value in the ecommerce environment as the delivery speed sensitivity of the buying cohort may be of medium level. In another example, customers purchasing medicines and living in metro cities may be the first buying cohort having an associated protection status as being protected and a high prioritization value. In another example, the prioritization value of a common buying cohort may be the low priority value in the ecommerce environment as the weighted preference value of the buying cohort is of a low level. In another example, the first buying cohort may be of a high priority value in the ecommerce environment as the weighted preference value of the buying cohort is high value, the geographical location of the first buying cohort is metro city and the item purchased is an electronic device. In another example, customers purchasing apparel and living in villages may be the second buying cohort having an associated protection status as being unprotected and a low prioritization value.

The capacity management module [104b] is further configured to determine an utilization value of a first capacity reservation for the identified first buying cohort. As used herein in this disclosure, a first capacity reservation and at least one second capacity reservation refer to predetermined capacity and a predetermined start time, an end time, and a total reserved capacity value assigned to the first buying cohort and the at least one second buying cohort respectively for each request received from a user device [102]. As used herein, the utilization value of a first capacity reservation and the at least one second capacity reservation may comprise of a numeric, alphanumeric, percentage, symbol or any other value indicating the already booked capacity of the first capacity reservation and at least one second capacity reservation which is available for capacity extraction. The utilization value has been mentioned as the first utilization value for the first capacity reservation. The capacity available for extraction has been mentioned as second extraction capacity value for at least one second capacity reservation in the disclosure. For example, first capacity reservation may have a total reserved capacity value of 100. In another example, the second capacity reservation may have a total reserved capacity value of 500. In yet another example, the second capacity reservation may have a total reserved capacity value of 500 and an extraction capacity value of 100 indicating that a capacity of 100 is available for extraction out of the total reserved capacity value of 500. The invention encompasses that the utilization value of the first capacity reservation and the at least one second capacity reservation has an associated at least one of the first buying cohort and the at least one second buying cohort and a predetermined start time, an end time, and a total reserved capacity value. For example, a first utilization value of a first capacity reservation for the identified first buying cohort may be 60, the total reserved capacity value being 100. In another example, a first utilization value of a first capacity reservation for the identified first buying cohort may be 99, the total reserved capacity value being 100. In yet another example, the first utilization value of a first capacity reservation for the first buying cohort may be 50 at 4 pm, the total reserved capacity value being 100, start time being 2 μm and end time being 6 pm. The capacity management module [104b] is further configured to dynamically assign extraction capacity value of at least one of a second capacity reservation to the first capacity reservation.

For example, the capacity management module [104b] may dynamically assign a second extraction capacity value of 50 from a second capacity reservation to the first capacity reservation. In another embodiment, the capacity management module [104b] may dynamically assign a second extraction capacity value of 20 from a second capacity reservation and a third extraction capacity value of 30 from a third capacity reservation to the first capacity reservation.

The invention encompasses that the capacity management module [104b] is further configured to dynamically assign an extraction capacity value of at least one of a second capacity reservation to the first capacity reservation only when an input is received from the spillage detector [104c] and the extraction planner module [104d].

The capacity management module [104b] is further configured to dynamically change the total reserved capacity value of the first capacity reservation based on the dynamically assigned extraction capacity value of the at least one second capacity reservation. For example, the capacity management module [104b] may dynamically change the total reserved capacity value of the first capacity reservation to 150 based on the dynamically assigned second extraction capacity value of 50 from a second capacity reservation when the initial total reserved capacity value of the first capacity reservation was 100. In embodiment, the capacity management module [104b] is configured to dynamically change the total reserved capacity value of the at least one second capacity reservation based on the dynamically assigned extraction capacity value of the at least one second capacity reservation to the first capacity reservation. For example, the capacity management module [104b] may be configured to dynamically change the total reserved capacity value of a second capacity reservation to 50 based on the dynamically assigned second extraction capacity value of 50 from the second capacity reservation when the initial total reserved capacity value of the second capacity reservation was 100.

The spillage detector [104c] is configured to determine whether the utilization value of the first capacity reservation is more than a predefined threshold value. The invention encompasses that the spillage detector [104c] is configured to determine if the first utilization value of the first capacity reservation is more than a predefined threshold value by comparing the identified first utilization value of the first capacity reservation and a predefined threshold value. As used in this disclosure, the “predefined threshold value” may be a value that represents a limit above which the utilization value of the first capacity reservation will almost reach the total reserved capacity value. In an example, a first utilization value 80 of the first capacity reservation for the first buying cohort may be compared with a predefined value of 95 to determine if the first utilization value of the first capacity reservation is above the pre-defined threshold value. In another example, a first utilization value 96 of the first capacity reservation for the first buying cohort may be compared with a predefined value of 95 to determine if the first utilization value of the first capacity reservation is above the pre-defined threshold value.

The spillage detector [104c] is further configured to generate an alert when the determined utilization value of the first capacity reservation is more than the predefined threshold value. As used herein, the alert may be one of a notification, message, sound, signal, color code or any other mechanism to generate an alert. In an example, a notification may be displayed with the first utilization value of 97 of the first capacity reservation for the first buying cohort when the determined utilization value of the first capacity reservation is more than the predefined threshold value of 95. In another example, a red color made be displayed with the first utilization value of 96 of the first capacity reservation for the first buying cohort when the determined utilization value of the first capacity reservation is more than the predefined threshold value of 95. The spillage detector [104c] is then configured to transmit the alert to the capacity management module [104b] and the extraction planner module [104d].

The extraction planner module [104d] is configured to identify at least one second capacity reservation. In an embodiment, the invention encompasses that the extraction planner module [104d] is configured to identify at least one second capacity reservation based on a dynamically forecasted demand determined by the forecasting module [104e] for the at least one second capacity reservation. In another embodiment, the invention encompasses that the extraction planner module [104d] is configured to identify at least one second capacity reservation based on a dynamically forecasted demand for the at least one second capacity reservation determined by the forecasting module [104e] and a risk factor determined for at least one second capacity reservation by the risk profiler [104f]. The extraction planner module [104d] is configured to transmit the identified at least one second capacity reservation to the capacity management module [104b].

The extraction planner module [104d] is further configured to determine the extraction capacity value of at least one second capacity reservation to be assigned to the first capacity reservation. The invention encompasses that the second extraction capacity value of at least one second capacity reservation is based on a dynamically forecasted demand associated with the second capacity reservation determined by the forecasting module [104e] and a risk factor determined by the risk profiler [104f]. In an embodiment, the second extraction capacity value of at least one second capacity reservation may also be based on the at least one of the dynamically forecast demand of the at least one of the second capacity reservation determined by the forecasting module [104e] and the risk factor determined by the risk profiler [104f].

In an embodiment, the invention encompasses that the extraction planner module [104d] is configured to prioritize at least one second capacity reservation. The prioritizing of the at least one second capacity reservation may be based on at least one of the dynamically forecasted demand of the at least one of the second capacity reservations determined by the forecasting module [104e] and the risk factor determined by the risk profiler [104f]. The prioritizing of at least one second capacity reservation may also be based on the prioritization value (dependent on delivery speed sensitivity) of the associated buying cohort. For example, the at least one second capacity reservation with high prioritization value will be below the at least one second capacity reservation with low prioritization value, such as at least one second capacity reservation with protection status as protected will be below the at least one second capacity reservation with protection status as being unprotected.

The invention encompasses that the extraction planner module [104d] is configured to determine the accuracy of the dynamically forecasted demand determined by the forecasting module [104e]. The accuracy of the dynamically forecasted demand is determined for at least one second capacity reservation. As used herein, the accuracy of the dynamically forecasted demand determined by the forecasting module [104e] is based on historical forecasted demand determined by the forecasting module [104e] and the actual received demand. For example, the accuracy of the dynamically forecasted demand determined by the forecasting module [104e] may be based on the last 3 forecasted demand determined by the forecasting module [104e] and the respective actual received demands for corresponding 3 time periods. Acting as a feedback loop, the extraction planner module [104d] is then configured to not identify at least one second capacity reservation for assigning a extraction capacity value to the first capacity reservation for a predetermined period of time based on the determined accuracy or error of the dynamically forecasted demand. The invention encompasses that the extraction planner module [104d] is then configured to not identify at least one second capacity reservation when the accuracy is less than a predefined threshold value. As used herein, when the accuracy is less than a predefined threshold value an error is determined by the extraction planner module [104d] in the dynamically forecasted demand. For example, the extraction planner module [104d] may stop identifying at least one second capacity reservation for a period of 24 hours when an error is determined by the extraction planner module [104d] in the dynamically forecasted demand for that second capacity reservation.

In a preferred embodiment, the accuracy of the dynamically forecasted demand is determined at the end time associated with a capacity reservation by the extraction planner module [104d]. For example, the extraction planner module [104d] may determine the accuracy of the dynamically forecasted demand at 4 μm, 6 pm and Bpm which are the end time associated with the capacity reservation. In another embodiment, the accuracy of the dynamically forecasted demand is determined dynamically by the extraction planner module [104d]. In yet another embodiment, the accuracy of the dynamically forecasted demand is determined periodically by the extraction planner module [104d]. For example, the extraction planner module [104d] may determine the accuracy of the dynamically forecasted demand after every two hours for at least one second capacity reservation.

The forecasting module [104e] is configured to dynamically forecast demand of at least one second capacity reservation associated with the at least one second buying cohort. The forecasting module [104e] is configured to dynamically forecast demand based on at least one of a season, periodicity, historical data, marketing strategy, recent cohort activity and the item inventory. The invention encompasses that the dynamically forecasted demand by the forecasting module [104e] is based on machine learning techniques. For example, the forecasting module [104e] may dynamically forecast the demand associated with a second buying cohort based on historical data and month of the year such as a high demand may be forecasted during a festival month every year. In another example, the forecasting module [104e] may dynamically forecast the demand associated with the second buying cohort based on season such as a high demand may be forecasted for the second buying cohort during winters.

The invention encompasses that the forecasting module [104e] is also configured to determine a forecasted demand precision value. As used herein, a forecasted demand precision value may comprise of a value, number, alphanumeric character, symbol or any other character that may denote the confidence in the dynamically forecasted demand for at least one second capacity reservation associated with the at least one second buying cohort.

The forecasting module [104e] is also configured to transmit the dynamically forecasted demand for at least one second capacity reservation to the capacity management module [104b] and the extraction planner module [104c]. In an embodiment, the forecasting module [104e] is also configured to transmit the forecasted demand precision value for at least one second capacity reservation to the capacity management module [104b] and the extraction planner module [104c].

The invention encompasses that the risk profiler [104f] is configured to determine a risk factor for capacity extraction associated with at least one second capacity reservation. For example, the risk profiler [104f] may be configured to determine a risk factor for a second capacity reservation and a third capacity reservation. As used herein, the risk factor may be a value, percentage, symbol, number, alphanumeric character or any other character to denote the risk associated with the capacity extraction from the capacity reservations. For example, the risk factor may be high denoting high risk for at least one of the second capacity reservations and low denoting high risk for at least one of the second capacity reservations. The risk factor for at least one of the second capacity reservations is based on at least one of the values of the second capacity reservation, the dynamically forecasted demand for the second capacity reservation determined by the forecasting module [104e] and forecasted demand precision value.

The invention encompasses that the risk factor for at least one second capacity reservation assigned to the first capacity reservation is a minimum. The risk profiler [104f] is configured to determine at least one second capacity reservation with the minimum risk factor such as “low”. For example, the capacity management module [104b] may dynamically assign a value of at least one from a second capacity reservation to the first capacity reservation where the risk factor determined by the risk profiler [104f] for the second capacity reservation is low.

In an embodiment, the risk profiler [104f] is configured to prioritize at least one of the second capacity reservations based on the determined risk factor. For example, the risk profiler [104f] may create a list of at least one of the second capacity reservations based on the risk factor determined for each of the at least one second capacity reservations. For instance, the risk profiler [104f] may identify and create a list of the second capacity reservations with the lowest determined risk factor followed by the second lowest determined risk factor.

The risk profiler [104f] is also configured to transmit the determined risk factor for at least one second capacity reservation to the capacity management module [104b] and the extraction planned module [104d].

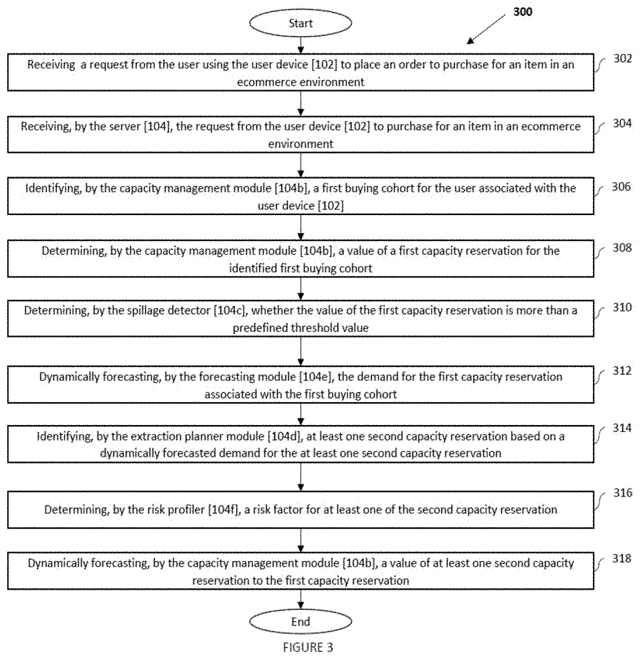

Now, FIG. 3 illustrates an exemplary flow chart of a method for optimizing platform conversion through dynamic management of capacity in an ecommerce environment in accordance with exemplary embodiments of the present invention.

At step 302, a request is received from the user of a user equipment [102]. The request received from the user may be to place an order to purchase an item in an ecommerce environment. In another embodiment, the request received from the user may be to return an item purchased in an ecommerce environment. For example, the user may click a soft button on a touch panel of the user equipment [102] to confirm a shopping request for a mobile device in an ecommerce platform. In another example, the user may confirm the purchase of an iPhone mobile and a dress from the ecommerce platform.

The request received from the user is then transmitted to the server [104] from the user equipment [102]. For example, the user equipment [102] may transmit the request received from the user for the purchase of a mobile device to the server [104].

At step 304, the request from the user device [102] is received by the server [104]. The request to place an order for at least one item on the ecommerce platform is received by the transceiver [104a]. For example, a request may be received to buy a mobile phone from a user device [102]. In another example, an order may be received from a user device [102] to buy clothes from the ecommerce platform.

At step 306, a first buying cohort for the user associated with the user device [102] is identified by the server [104]. The first buying cohort for the user associated with the user device [102] is identified by the capacity management module [104b].

The invention encompasses that the first buying cohort has an associated first prioritization value. In an embodiment, at least one second buying cohort has an associated second prioritization value. For example, the prioritization value of the first buying cohort may be the first priority value in the ecommerce environment as the delivery speed sensitivity of the buying cohort is high. In another example, the prioritization value of a second buying cohort may be the second priority value in the ecommerce environment as the weighted preference value of the buying cohort may be of medium value. In another example, the prioritization value of a third buying cohort may be a low priority value in the ecommerce environment as the item purchased may be apparel. In another example, the first buying cohort may be of a high priority value in the ecommerce environment as the delivery speed sensitivity of the buying cohort is high, the geographical location of the first buying cohort is metro city and the item purchased is an electronic device.

At step 308, a utilization value of a first capacity reservation for the identified first buying cohort is determined. The invention encompasses that the first utilization value of a first capacity reservation for the identified first buying cohort is determined by the capacity management module [104b]. For example, first capacity reservation may have the first utilization value of 30 at 2 μm and total reserved capacity value of 100. In another example, the second capacity reservation may have the first utilization of 0 at 2 μm and the total reserved capacity value of 500. The invention encompasses that the value of the first capacity reservation and the second capacity reservation has an associated first buying cohort and at least one of the second buying cohort, a start time, an end time, and a total reserved capacity value. For example, a first utilization value of a first capacity reservation for the identified first buying cohort may be 60, the total reserved capacity value of the first buying cohort being 100. In another example, the first utilization value of a first capacity reservation for the identified first buying cohort may be 99, the total reserved capacity value of the first buying cohort being 100 for the time period of 2 μm to 4 pm. In yet another example, the first utilization value of a first capacity reservation for the first buying cohort may be 50 at 4 pm, the total reserved capacity value of the first buying cohort being 100, start time being 2 μm and end time being 6 pm.

At step 310, the first utilization value of the first capacity reservation is determined to be more than a predefined threshold value by the spillage detector [104c]. The invention encompasses that the first utilization value of the first capacity reservation is determined more than a predefined threshold value by comparing the identified value of the first capacity reservation and a predefined threshold value. For example, the first utilization value 50 of the first capacity reservation for the first buying cohort may be compared with a predefined value of 99 to determine that the first utilization value of the first capacity reservation is below the predefined threshold value. In another example, the first utilization value 96 of the first capacity reservation for the first buying cohort may be compared with a predefined value of 90 to determine that the first utilization value of the first capacity reservation is above the pre-defined threshold value. The alert may then be transmitted to the capacity management module [104b] and the extraction planner module [104d] by the spillage detector [104c] if the first utilization value of the first capacity reservation is determined to be more than a predefined threshold value.

The invention further encompasses that an alert may be generated when the determined value of the first capacity reservation is more than the predefined threshold value. In an example, a notification may be displayed with the word “OVERFLOW” for the first buying cohort when the first utilization value of the first capacity reservation is determined to be above a predefined value. In another example, a red color may be made to blink when the first utilization value of the first capacity reservation for the first buying cohort is determined to be above a predefined value.

At step 312, if the first utilization value of the first capacity reservation is determined to be more than a predefined threshold value by the spillage detector [104c] at step 310, the demand for at least one second capacity reservation associated with at least one second buying cohort is dynamically forecasted. The invention encompasses that the dynamically forecasted demand is determined using machine learning techniques. The demand is dynamically forecasted based on at least one of a season, periodicity, historical data, marketing strategy, recent cohort activity, and the item inventory. The demand for at least one second capacity reservation associated with at least one second buying cohort is dynamically forecasted by the forecasting module [104e]. For example, the forecasting module [104e] may dynamically forecast the demand associated with the second capacity reservation based on historical data and month of the year such as a high demand may be forecasted during a festival month every year.

The invention encompasses that a forecasted demand precision value is also determined by the forecasting module [104e]. The forecasted demand precision value is associated with the dynamically forecasted demand for the second capacity reservation and is derived from confidence intervals of prediction and the forecasted demand. For example, a forecasted demand precision value of high may be associated with the dynamically forecasted demand of 10 for the second capacity reservation for which the confidence interval could be (9,11).

At step 314, at least one second capacity reservation is identified by the extraction planner module [104d]. The identification of at least one second capacity reservation is based on a dynamically forecasted demand for at least one second capacity reservation. The demand is dynamically forecasted based on at least one of a season, periodicity, historical data, marketing strategy, recent cohort activity, and the item inventory. The invention encompasses that the dynamically forecasted demand by the forecasting module [104e] is based on machine learning techniques. For example, the forecasting module [104e] may dynamically forecast the demand associated with the second capacity reservation based on season such as a high demand may be forecasted for the second capacity reservation associated with the second buying cohort during winters.

The invention encompasses that the dynamically forecasted demand for at least one second capacity reservation is transmitted to the capacity management module [104b] and the extraction planner module [104c]. The invention encompasses that at least one second capacity reservation is identified based on the dynamically forecasted demand for at least one second capacity reservation associated with at least one second buying cohort. In a preferred embodiment, the demand for all the second capacity reservations are dynamically forecasted. Thereafter, at step 316, the risk factor for at least one of the second capacity reservations is determined by the risk profiler [104f]. The risk factor for at least one of the second capacity reservations is based on at least one of the values of the second capacity reservation, the dynamically forecasted demand for the second capacity reservation and forecasted demand precision value.

The invention encompasses that the risk factor for the at least one second capacity reservation is a minimum. The invention encompasses that at least one second capacity reservation with the minimum risk factor, such as “low risk” is determined. In an embodiment, at least one of the second capacity reservations is prioritized by the risk profiler [104f]. For example, a list may be created by the risk profiler [104f] of at least one of the second capacity reservations based on the risk determined for each of the at least one second capacity reservation. For instance, the risk profiler [104f] may identify two second capacity reservations with the lowest determined risk factor and the second lowest determined risk factor.

The determined risk factor for at least one of the second capacity reservations is then transmitted to the capacity management module [104b].

Although steps 314 and 316 are disclosed herein in a sequential manner, the invention encompasses that the steps 314 and 316 may be performed concurrently.

Finally, at step 318, a second extraction capacity value of at least one second capacity reservation is dynamically assigned to the first capacity reservation by the capacity management module [104b]. The invention encompasses that the second extraction capacity value of at least one second capacity reservation is based at least on a dynamically forecasted demand for the second capacity reservation at step 312 and a risk factor determined at step 314. In an embodiment, the invention encompasses that the at least one second capacity reservation may be prioritized by the extraction planner module [104d]. The prioritizing of the at least one second capacity reservation may be based on at least one of the dynamically forecasted demand of the at least one of the second capacity reservations determined, the forecasted demand precision value at step 312 and the risk factor determined at step 314. For example, the capacity management module [104b] may dynamically assign a second extraction capacity value of 50 from the second capacity reservation to the first capacity reservation. In another example, the capacity management module [104b] may dynamically assign a second extraction capacity value of 20 from the second capacity reservation and a third extraction capacity value of 30 from the third capacity reservation to the first capacity reservation.

The invention encompasses that the total reserved capacity value of the first capacity reservation may be dynamically changed based on the dynamically assigned extraction capacity value of the second capacity reservation. For example, the total reserved capacity value of the first capacity reservation may be dynamically changed to 150 based on the dynamically assigned extraction capacity value of 50 from the second capacity reservation when the initial total reserved capacity value of the first capacity reservation was 100.

The invention encompasses that the total reserved capacity value of at least one second capacity reservation may be dynamically changed based on the dynamically assigned extraction capacity value of the second capacity reservation to the first capacity reservation. For example, the total reserved capacity value of the second capacity reservation may be dynamically changed to 50 based on the dynamically assigned extraction capacity value of 50 from the second capacity reservation when the initial total reserved capacity value of the second capacity reservation was 100.

The invention encompasses that an accuracy of the dynamically forecasted demand is determined by the extraction planner module [104d] in order to be used as feedback on prediction. The accuracy of the dynamically forecasted demand is determined for at least one second capacity reservation. For example, the accuracy of the dynamically forecasted demand determined by the forecasting module [104e] may be based on the last 3 forecasted demand determined by the forecasting module [104e] and the respective actual received demands for corresponding 3 time periods.

The invention encompasses that at least one second capacity reservation for assigning a extraction capacity value to the first capacity reservation is not identified by the extraction planner module [104d] for a predetermined period of time based on the determined accuracy of the dynamically forecasted demand. The at least one second capacity reservation is not identified when the accuracy of the dynamically forecasted demand is less than a predefined threshold value. For example, at least one second capacity reservation may not be identified for a period of 24 hours when an error is determined in the dynamically forecasted demand for that second capacity reservation. The accuracy of the dynamically forecasted demand may be determined at the end time associated with a capacity reservation, periodically or dynamically by the extraction planner module [104d].

In an exemplary embodiment, the invention commences when a request is received from a user of a user equipment [102] to place an order to purchase for an item, such as a mobile device, in an ecommerce environment. The request received from the user to purchase a mobile device is then transmitted to the server [104] from the user equipment [102]. The server [104] receives the request from the user device [102] to purchase a mobile device from the ecommerce platform. Upon receipt of the request, the server [104] identifies a first buying cohort for the user associated with the user device [102]. The identified first buying cohort may have an associated first priority value in the ecommerce environment as the item purchased is an electronic device, the geographical location is a metro city and the delivery speed sensitivity of the first buying cohort is high.

Thereafter, a first utilization value of 99 may be determined for the associated first capacity reservation for the identified first buying cohort by the capacity management module [104b]. The first utilization value of 99 may be determined at the time of receipt of request, such as 2 pm. The total reserved capacity value for the first capacity reservation may be 100. The first utilization value of 99 for the first capacity reservation is then determined to be more than a predefined threshold value by the spillage detector [104c]. The first utilization value of 99 for the first capacity reservation is determined more than a predefined threshold value of 95 by comparing the identified first utilization value (99) of the first capacity reservation and a predefined threshold value of 95. An alert may then be generated by the spillage detector [104c] if the first utilization value of 99 for the first capacity reservation is determined to be more than a predefined threshold value of 95 by displaying a notification with the word “OVERFLOW” for the first buying cohort.

Thereafter, at least one second capacity reservation is identified by the extraction planner module [104d]. The identification is based on a dynamically forecasted demand for at least one second capacity reservation. The demand for all the second capacity reservations is then dynamically forecasted. A demand of 50 may be dynamically forecasted for the second capacity reservation, the total reserved capacity value being 200 and the extraction capacity value being 10. Also, a demand of 10 may be dynamically forecasted for a third capacity reservation, the total reserved capacity value being 500 and the extraction capacity value being 100. The invention encompasses that a forecasted demand precision value is also determined by the forecasting module [104e] for the second capacity reservation and the third capacity reservation. The dynamically forecasted demand of 50 for the second capacity reservation and 10 for the third capacity reservation is transmitted to the capacity management module [104b] and the extraction planner module [104c].

Thereafter, a risk factor for the second capacity reservation and the third capacity reservation is determined by the risk profiler [104f]. The risk factor for the second capacity reservation and the third capacity reservation may be determined to be low. The second capacity reservation and the third capacity reservation may then be prioritized by the risk profiler [104f] in a list. The risk factor for the third capacity reservation may be the lowest followed by the second capacity reservation. The determined risk factor for the second capacity reservation and the third capacity reservation is then transmitted to the capacity management module [104b].

Finally, a third extraction capacity value of 30 and a second extraction capacity value of 20 of the third capacity reservation and the second capacity reservation respectively is dynamically assigned to the first capacity reservation by the capacity management module [104b]. Further, the invention encompasses that the total reserved capacity value of the first capacity reservation may be dynamically changed to 150 based on the dynamically assigned third extraction capacity value of 30 and a second extraction capacity value of 20 of the third capacity reservation and the second capacity reservation respectively, the initial total capacity reservation value being 100. Further, the invention encompasses that an accuracy of the dynamically forecasted demand determined by the forecasting module [104e] may be determined periodically by the extraction planner module [104d] based on the last 3 forecasted demands and the respective actual received demands for corresponding 3 time periods. The accuracy of the dynamically forecasted demand is determined for the second capacity reservation and the third capacity reservation to be used as a feedback on prediction. An error in forecasts may be determined if the forecasted demand for the second capacity reservation is 50, actual received demand for the same buying cohort in the same time period is 55 and difference of both (5) as a percentage of actual received demand (55) is greater than the acceptable error threshold. In such a case, the extraction planner module [104d] may stop identifying the corresponding second capacity reservation for a period of 24 hours so that erroneous data is not used for capacity rebalancing.

As evident from the above description, the present disclosure provides for a method and system for an intelligent and automated mechanism for managing capacity reservations, created for one or more buying cohorts according to their delivery speed sensitivity, while taking into account the various risks associated with each capacity. The present invention ensures that the risk factor, including varying delivery speed sensitivity, and a forecasted demand associated with each buying cohort is taken into account for dynamically managing capacity reservations. The present invention also provides for reallocation of capacity reservations based on minimum risk associated with capacity reservation management. Hence, the present invention further ensures an increase in the conversion rate of the buying cohorts. Therefore, the present disclosure provides for optimizing platform conversion through dynamic management of capacity in an ecommerce environment.

The units, interfaces, modules, and/or components depicted in the figures and described herein may be present in the form of a hardware, a software and a combination thereof. Connection/s shown between these units/components/modules/interfaces in the exemplary system architecture may interact with each other through various wired links, wireless links, logical links and/or physical links. Further, the units/components/modules/interfaces may be connected in other possible ways.

While considerable emphasis has been placed herein on the disclosed embodiments, it will be appreciated that many embodiments can be made and that many changes can be made to the embodiments without departing from the principles of the present invention. These and other changes in the embodiments of the present invention will be apparent to those skilled in the art, whereby it is to be understood that the foregoing descriptive matter to be implemented is illustrative and non-limiting.

1. A method for optimizing platform conversion through dynamic management of capacity in an ecommerce environment, the method comprising:
receiving, by a user equipment [102], a request to place an order for an item in the ecommerce environment;
identifying, by a server [104], a first buying cohort for a user with an associated first prioritization value;
determining, by the server [104], a first utilization value of a first capacity reservation for the identified first buying cohort;
dynamically assigning, by the server [104], a second extraction capacity value of at least one second capacity reservation to the first capacity reservation in an event that the determined first utilization value of the first capacity reservation is more than a predefined threshold value to manage the capacity of the first capacity reservation in the ecommerce environment;
wherein the second extraction capacity value of the at least one second capacity reservation assigned to the first capacity reservation is based on a dynamically forecasted demand associated with at least one of the second capacity reservations, and a risk factor.

2. The method as claimed in claim 1, further comprising generating, by the server [104], an alert when the determined first utilization value of the first capacity reservation is more than the predefined threshold value.

3. The method as claimed in claim 1, further comprising dynamically changing, by the server [104], a total reserved capacity value of the first capacity reservation based on the assigned second extraction capacity value of the second capacity reservation.

4. The method as claimed in claim 1, further comprising identifying, by the server [104], the second capacity reservation based on at least one of the dynamically forecasting demand of at least one of the second capacity reservations and the risk factor.

5. The method as claimed in claim 1, further comprising determining, by the server [104], an accuracy of the dynamically forecasted demand.

6. The method as claimed in claim 1, wherein the prioritization value of the first customer cohort and the second customer cohort is based on at least one of a weighted preference value and the delivery speed sensitivity.

7. The method as claimed in claim 1, wherein the first capacity reservation and second capacity reservation have an associated at least one of the first buying cohort and the second buying cohort and a predetermined start time, an end time and a total reserved capacity value.

8. The method as claimed in claim 1, wherein the first utilization value and the second utilization value has an associated at least one of the first capacity reservation and the second capacity reservation.

9. The method as claimed in claim 1, wherein the dynamically forecasted demand for at least one second capacity reservation is based on at least one of a season, periodicity, historical data, marketing strategy, recent cohort activity and the item inventory.

10. The method as claimed in claim 1, wherein the risk factor of the value of the at least one second capacity reservation is a minimum.

11. The method as claimed in claim 1, wherein the risk factor for at least one of the second capacity reservations is based on at least one of the reserved capacity for second capacity reservation, the dynamically forecasted demand for the second capacity reservation and the confidence in prediction.

12. The method as claimed in claim 1, wherein the dynamically forecasted demand is determined using machine learning techniques.

13. A system for optimizing platform conversion through dynamic management of capacity in an ecommerce environment, the system comprising:
a user equipment [102] configured to transmit a request to place an order for at least one item in the ecommerce environment;
a server [104] configured to identify a first buying cohort for a user with an associated first prioritization value and determine a first utilization value of a first capacity reservation for the identified first buying cohort;
wherein the server [104] is further configured to dynamically assign a second extraction capacity value of at least one of a second capacity reservation to the first capacity reservation in an event that the determined first utilization value of the first capacity reservation is more than a predefined threshold value to manage the capacity of the first capacity reservation in the ecommerce environment, the second extraction capacity value of the at least one second capacity reservation assigned to the first capacity reservation being based on a dynamically forecasted demand associated with at least one of the second capacity reservation, and a risk factor.

14. The system as claimed in claim 12, wherein the server [104] is further configured to generate an alert when determined first utilization value of the first capacity reservation is more than the predefined threshold value.

15. The system as claimed in claim 12, wherein the server [104] is further configured to dynamically change a total reserved capacity value of the first capacity reservation based on the dynamically assigned second extraction capacity value of the second capacity reservation.

16. The system as claimed in claim 12, wherein the server [104] is further configured to identify the second capacity reservation based on at least one of the dynamically forecast demand of at least one of the second capacity reservations and the risk factor.

17. The system as claimed in claim 12, wherein the server [104] is further configured to determine an accuracy of the dynamically forecasted demand.

18. The system as claimed in claim 12, wherein the first capacity reservation and second capacity reservation have an associated at least one of the first buying cohort and the second buying cohort and a predetermined start time, an end time and a total reserved capacity value.

19. The system as claimed in claim 12, wherein the first utilization value and the second utilization value has an associated at least one of the first capacity reservation and the second capacity reservation.

20. The system as claimed in claim 12, wherein the dynamically forecasted demand for at least one second capacity reservation is based on at least one of a season, periodicity, historical data, marketing strategy, recent cohort activity, and the item inventory.

21. The system as claimed in claim 12, wherein the risk factor of the value of a second capacity reservation assigned is a minimum.

22. The system as claimed in claim 12, wherein the risk factor for at least one of the second capacity reservations is based on at least one of the reserved capacity for second capacity reservation, the dynamically forecasted demand for the second capacity reservation and the confidence in prediction.

23. The system as claimed in claim 12, wherein the server [104] is further configured dynamically forecast demand based on machine learning techniques.
